(19) United States
(12) Patent Application Publication
(10) Pub. No.: US 2017/0118518 A1
(43) Pub. Date: Apr. 27, 2017

(54) METHOD AND APPARATUS FOR PROVIDING SOCIAL INTERACTION WITH PROGRAMMING CONTENT

(71) Applicant: Nokia Corporation, Espoo (FI)

(72) Inventors: Rajeswari KANNAN, Bangalore (IN); Timo Tapani AALTONEN, Tampere (FI); Yan Qing CUI, Helsinki (FI)

(21) Appl. No.: 15/397,335

(22) Filed: Jan. 3, 2017

Related U.S. Application Data
(63) Continuation of application No. 13/765,137, filed on Feb. 12, 2013, now abandoned.

(30) Foreign Application Priority Data
Feb. 14, 2012 (IN) 539/CHE/2012

(51) Int. Cl. H04N 21/466; H04N 21/482; H04N 21/442; H04N 21/4627; H04N 21/258; H04N 21/25; H04N 21/2668; H04N 21/4788; H04N 21/4223

(52) U.S. Cl. CPC H04N 21/4667; H04N 21/4788; H04N 21/4826; H04N 21/44218; H04N 21/4223; H04N 21/25891; H04N 21/251; H04N 21/2668; H04N 21/4627

(57) ABSTRACT

An approach is provided for providing social interactions with programming content. The tracking platform processes and/or facilitates a processing of one or more images of one or more users watching programming content to cause, at least in part, an identification of the one or more users. Next, the tracking platform determines one or more social connections among the one or more users, one or more other users, or a combination thereof. Then, the tracking platform causes, at least in part, a transmission of status information associated with the one or more users, the one or more other users, the programming content, or a combination thereof.

### CROSS REFERENCE TO RELATED APPLICATIONS

This application is a continuation of U.S. patent application Ser. No. 13/765,137, filed Feb. 12, 2013, entitled “METHOD AND APPARATUS FOR PROVIDING SOCIAL INTERACTION WITH PROGRAMMING CONTENT”, the entire disclosure of which is hereby incorporated by reference herein.

### BACKGROUND

Service providers and device manufacturers (e.g., wireless, cellular, etc.) are continually challenged to deliver value and convenience to consumers by, for example, providing compelling network services. One area of interest has been the development of services and technologies related to watching programming content. For example, the advancement of the remote controls for watching programming content has greatly increased the ease and convenience of watching programming content. A single, universal remote control, for instance, enable users to interact with a number of devices, including a television, a video player, and/or home theater systems. Nonetheless, services and technologies related to watching programming content still only provide users limited interactions, for instance, with the programming content.

### SOME EXAMPLE EMBODIMENTS

Therefore, there is a need for an approach for providing social interaction with programming content.

According to one embodiment, a method comprises processing and/or facilitating a processing of one or more images of one or more users watching programming content to cause, at least in part, an identification of the one or more users. The method also comprises determining one or more social connections among the one or more users, one or more other users, or a combination thereof. The method further comprises causing, at least in part, a transmission of status information associated with the one or more users, the one or more other users, the programming content, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of one or more images of one or more users watching programming content to cause, at least in part, an identification of the one or more users. The apparatus is also caused to determine one or more social connections among the one or more users, one or more other users, or a combination thereof. The apparatus is further caused to cause, at least in part, a transmission of status information associated with the one or more users, the one or more other users, the programming content, or a combination thereof.

According to another embodiment, a computer-readable storage medium carries one or more sequences of one or more instructions which, when executed by one or more processors, cause, at least in part, an apparatus to process and/or facilitate a processing of one or more images of one or more users watching programming content to cause, at least in part, an identification of the one or more users. The apparatus is also caused to determine one or more social connections among the one or more users, one or more other users, or a combination thereof. The apparatus is further caused to cause, at least in part, a transmission of status information associated with the one or more users, the one or more other users, the programming content, or a combination thereof.

According to another embodiment, an apparatus comprises means for processing and/or facilitating a processing of one or more images of one or more users watching programming content to cause, at least in part, an identification of the one or more users. The apparatus also comprises means for determining one or more social connections among the one or more users, one or more other users, or a combination thereof. The apparatus further comprises means for causing, at least in part, a transmission of status information associated with the one or more users, the one or more other users, the programming content, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing social interactions with programming content, according to one embodiment;

FIG. 2 is a diagram of the components of a tracking platform, according to one embodiment;

FIG. 3A is a flowchart of a process for providing social interactions with programming content, according to one embodiment;

FIG. 3B is a use case diagram for providing social interactions with programming content, according to one embodiment;

FIG. 4 is a flowchart of a process for providing presentations based on status information, according to one embodiment;

FIG. 5 is a flowchart of a process for providing presentations of status information, commenting information, and/or communication sessions, according to one embodiment;

FIG. 6 is a flowchart of a process for using gestures to initiate actions, according to one embodiment;

FIG. 7 is a diagram of a user interface illustrating social interactions with programming content, according to one embodiment;

FIG. 8 is a diagram illustrating the use of gestures to initiate actions, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing social interactions with programming content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

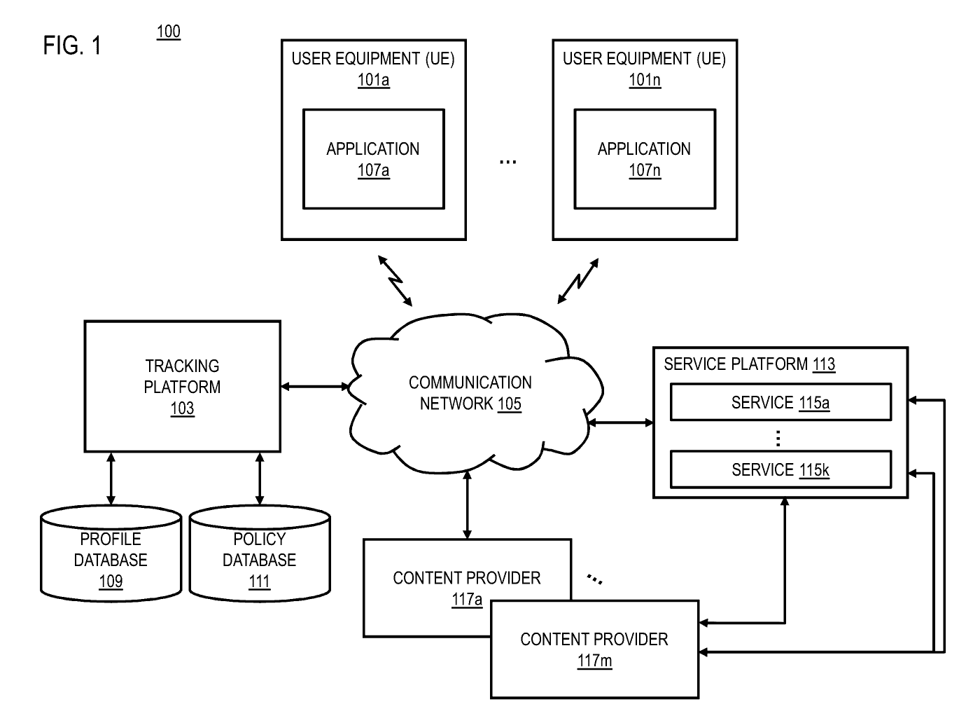

FIG. 1 is a diagram of a system capable of providing social interactions with programming content, according to one embodiment. As discussed, in recent years, the development of services and technologies for interacting with televisions, video players, home theater systems, etc., have greatly increased the ease and convenience of watching programming content. For example, a single, universal remote control now enables a user to watch and interact with any number of devices, including a television, a video player, and/or home theater systems. As mentioned, however, services and technologies related to watching programming content still has room to improve the digital experience provided to users (e.g., while at home in front of the television screen, on the go with a mobile device, etc.), which may, for instance, include enhancing the interactions with devices rendering such programming content, adding a social community experience to watching programming content, etc.

To address this problem, a system 100 of FIG. 1 introduces the capability to provide social interactions with programming content. Specifically, the system 100 may process images of a user watching programming content to identify the user. Once the user is identified, the system 100 may also determine one or more social connections between the user and other users. By way of example, the system 100 may access the user's phone contacts to determine that the user and the other users are connected with each other (e.g., as friends) on one or more social networks. The system 100 may further transmit status information associated with the user, the other users, and/or the programming content. It is noted that although various embodiments are described with respect to face tracking and/or gaze tracking, it is contemplated that the approach described herein may be used with other techniques, such as facial recognition, gesture recognition, gender and age estimations, mood recognition, etc.

In one scenario, users A and B (who is a friend of user A) may be watching programming content in their respective homes. User A may be watching programming content on channel A on her television, and user B watching another programming content on channel B on his tablet device. While users A and B are watching their respective programming content, the television (e.g., equipped with a video camera) may capture one or more images of user A, and the tablet device (e.g., equipped with a video camera) may capture one or more images of user B. As indicated, the images may be used to identify users A and B. In addition, the images may also be utilized to determine that user A is watching channel A's programming content on the television and that user B is watching channel B's programming content on the tablet device (e.g., user A is looking directly at the television and user B is looking directly at the tablet device). Such information may, for instance, be included in the respective status information for users A and B. In some cases, after determining that users A and B are friends through their social network connections, user A's status information may be transmitted to user B, and user B's status information may be transmitted to user A.

In another scenario, there may be other members of the household with user A watching the programming content on channel A. User A may, for instance, be set as the primary user for the family television. As such, priority may be given to user A over the other members of the household when more than one user is watching the television at the same time. For example, when there are multiple users detected and identified by the television (e.g., connected with the system 100), information associated with the identified, highest-priority user may be utilized to determine that user's social connections with other users. That is, in some embodiments, status information of that user may only be transmitted to the other users with social connections to that user, and that user may only receive status information of other users who have social connections to that user. Moreover, in certain embodiments, recommendations may also generated for the highest-priority user based on the status information where there are multiple users watching the programming content on the same device. In other embodiments, however, recommendations may be reserved (e.g., no recommendations will be presented) when there are multiple users watching the programming content on the same device (e.g., the family television). Instead, in such embodiments, the recommendations may be held until it is determined that only one user is watching the programming content on the device.

As shown in FIG. 1, the system 100 comprises a user equipment (UE) 101 (or multiple UEs 101a-101n) having connectivity to a tracking platform 103 via a communication network 105. The UE 101 may include or have access to an application 107 (e.g., applications 107a-107n) to enable the UE 101 to interact with, for instance, the tracking platform 103, which may: (1) process images of users watching programming content to identify those users; (2) determine social connections among those users and/or other users; (3) transmit status information associated with those users, the other users, and/or the programming content (e.g., based on one or more privacy policies associated with those users, the other users, and/or the programming content); (4) process the images to determine face tracking information, gaze tracking information, and/or gestures (e.g., for determining the status information); (5) determine devices for presenting the programming content and/or the status information based on the face tracking information, the gaze tracking information, and/or the gestures; or (6) perform other functions. The tracking platform 103 may include or have access to a profile database 109 to access or store images of users (e.g., exemplary images for recognition purposes), status information, commenting information, preferences, social network data, etc. The tracking platform 103 may also include or have access to a policy database 111 to access or store policies relating to the users, the UEs 101, or the programming content, etc. Data stored in the profile database 109 and the policy database 111 may, for instance, be provided by the UEs 101, a service platform 113, one or more services 115 (or services 115a-115k), one or more content providers 117 (or content providers 117a-117m), and/or other services available over the communication network 105. For example, a certain service 115 may provide default privacy policies for the users based on the programming content (e.g., status information with respect to programming content with certain ratings may initially not be shared). However, the user of a particular UE 101 may, for instance, update her individual preferences, including modifications of those default privacy policies. It is noted that the tracking platform 103 may be a separate entity of the system 100, a part of the one or more services 115 of the service platform 113, or included within the UE 101 (e.g., as part of the application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the tracking platform 103 may process and/or facilitate a processing of the one or more images to determine face tracking information, gaze tracking information, or a combination thereof. The tracking platform 103 may then determine the status information based, at least in part, on the face tracking information, the gaze tracking information, or a combination thereof. By way of example, the tracking platform 103 may utilize user A's television (e.g., equipped with a video camera) to capture images (e.g., image/video frames) of user A while she is in front of the television and the programming content is playing on the television. The location of user A's face in each of the captured images, the tilt and angle of user A's head in each of the captured images, etc., may, for instance, be used to determine the identity of the detected face (e.g., user A's face) along with the face tracking information. Additionally, or alternatively, such information (e.g., location, tilt, angle, etc., of user A's face/head) may be used in conjunction with detected eye positions and eye movement to determine the gaze tracking information. As such, the face tracking information and/or the gaze tracking information may be used to predict what user A is, or will be, looking at. If, for instance, it is determined that user A is looking at the television while the television is tuned to channel A, the tracking platform 103 may thus determine the status information that includes data to reflect that user A is watching channel A's programming content on the particular television (e.g., the television that user A is looking at).

By way of another example, user B may be in front of his television (e.g., equipped with a video camera) with his tablet device (e.g., equipped with a video camera) beside him. If, for instance, it is determined that user B is looking at the tablet device while the tablet device is playing channel B's programming content, the tracking platform 103 may determine that user B is watching the particular programming content playing on his tablet device instead of any programming content that is playing on his television. As indicated, this determination may be made through the detected face tracking information and/or gaze tracking information by processing, for instance, the images captured by user B's television and tablet device. Accordingly, the tracking platform 103 may, for instance, generate the status information to reflect such a determination.

In another embodiment, the tracking platform 103 may determine one or more devices for presenting the programming content, the status information, or a combination thereof based, at least in part, on the face tracking information, the gaze tracking information, or a combination thereof. The one or more devices may, for instance, include, at least in part, a television, a monitor, a mobile device, or a combination thereof associated with the one or more users, the one or more other users, or a combination thereof. It is noted that, in certain embodiments, the tracking platform 103 may cause, at least in part, a rendering of a user interface depicting, at least in part, the programming content and the status information. In one scenario, a user may be watching programming content on her television with her mobile device in her hand. The tracking platform 103 may, for instance, determine that the user is looking directly at the television based on the face tracking information and/or the gaze tracking information. As such, the tracking platform 103 may determine to present both the programming content and the status information associated with the user's friend (e.g., “Your friend is currently using his tablet device to watch program B on channel B”) on the television screen without obstructing the programming content being watched. In this way, the status information may only need to be presented on the television for a short period of time (e.g., to avoid interference with the programming content) and still enable the status information to reach the targeted user.

In a further scenario, the user may look away from the television and start focusing her attention on her mobile device. The user may, for instance, be browsing a social network site using her mobile device. As such, the tracking platform 103 may determine from the face tracking information and/or the gaze tracking information that the user's attention is directed at her mobile device. Consequently, the tracking platform 103 may, for instance, present the status information of the user's friend (e.g., “Your friend is now watching program C on channel C on his television and has been watching program C on channel C for the last five minutes”) on the user's mobile device by overlaying the status information over the social networking site. Alternatively, the tracking platform 103 may present the status information on the user's mobile device by integrating the presentation of status information with the social networking site (e.g., by displaying the friend's status information as a highlighted status among other statuses on the social networking site).

In another embodiment, the tracking platform 103 may determine one or more privacy policies associated with the one or more users, the one or more other users, the programming content, or a combination thereof. In a further embodiment, the transmission of the status information may be based, at least in part, on the one or more privacy policies. By way of example, the tracking platform 103 may implement default privacy policies that limit the transmission of status information associated with particular categories of programming content (e.g., to prevent generally private matters from being transmitted as status information). Users may thereafter modify these default privacy policies and/or add additional policies to customize their own individual privacy preferences. A user may, for instance, enable sharing of the user's status information with certain users (e.g., designated, close friends) and disable sharing of the status information with other users (e.g., non-friends).

In another embodiment, the tracking platform 103 may process and/or facilitate a processing of the status information to determine one or more recommendations relating to other programming content, advertising content, or combination thereof. The tracking platform 103 may then cause, at least in part, a presentation of the one or more recommendations at one or more devices associated with the one or more users, the one or more other users, or a combination thereof. In one use case, when the tracking platform 103 determines that user A and B are friends via their social networking connections, user A may be recommended programming content (e.g., on channel B) that user B is currently watching on his tablet device, and user B may be recommended programming content (e.g., on channel A) that user A is currently watching on her television. As an example, when user B is currently watching channel B's programming content on his tablet device, user B may, for instance, receive a recommendation on the tablet device (e.g., without obstructing the presentation of channel B's programming content), stating that “User A is currently watching program A on channel A. Tap this status here to watch program A on channel A using your tablet device.” In a further use case, user B may also be recommended one or more products of advertising content, famous celebrities, places, awards, etc., that user A has indicated that she liked while she was watching program A on channel A using her television (e.g., user A may gesture with a thumbs-up when the products, the famous celebrities, the places, the awards, etc., are presented to indicate that she liked those particular things).

In another embodiment, the tracking platform 103 may determine to associate the status information, commenting information, one or more communication sessions, or a combination thereof with the programming content, related programming content, or a combination thereof. The tracking platform 103 may cause, at least in part, a presentation of the status information, the commenting information, the one or more communication sessions, or a combination thereof based, at least in part, on determining at least one request for the programming content, the related programming content, or a combination thereof. In one scenario, the tracking platform 103 may be utilized as part of a social networking service where subscribers who are friends may get recommendations from each other with respect to programming content they've already watched or to be watched, etc. In addition, the friends may exchange conversations about the programming content and/or related programming content, which may include comments left on each other's comments, chat room communication sessions, phone conversations, etc. These conversations may thereafter be associated with the programming content and/or the related programming content. Thus, when a subscriber initiates a request for the programming content and/or the related programming content, the tracking platform 103 may, for instance, present to the subscriber one or more of those conversations associated with the requested content.

In another embodiment, the tracking platform 103 may cause, at least in part, an initiation of the presentation of the status information, the commenting information, the one or more communication sessions, or a combination thereof based, at least in part, on a recognition of the one or more users, at least one of the one or more other users, or a combination thereof. In one use case, when the tracking platform 103 recognizes a subscriber that is detected to be looking at his television (e.g., through face and gaze tracking), it may render the subscriber's watching history (e.g., channel information, programming content, advertising content, etc.) to the subscriber along with what the subscriber's friends think about the respective items in the subscriber's history (e.g., based on commenting information, the communication sessions, etc.). Additionally, or alternatively, the tracking platform 103 may present the subscriber with other items (e.g., channels, programming content, advertising content, etc.), for instance, that the subscriber's friends have recommended and are currently being offered (e.g., via the electronic programming guide, via on-demand services, etc.).

In another embodiment, the tracking platform 103 may process and/or facilitate a processing of the one or more images to determine one or more gestures. The tracking platform 103 may cause, at least in part, an initiation of (a) the transmission of the status information; (b) one or more actions associated with the programming content, the one or more social connections, or a combination thereof; or (c) a combination thereof based, at least in part, on the one or more gestures. In one scenario, a user may provide gestures, such as a thumbs-up, thumbs-down, etc., to indicate whether the user likes or dislikes a particular broadcast program that is playing on the user's television. As an example, if the user gives a thumbs-up gesture while watching a particular broadcast program on her television, the thumbs-up gesture may be detected via the one or more images captured by the television's video camera. Upon determining that that user has given the thumbs-up gesture to the broadcast program, the tracking platform 103 may, for instance, cause an transmission of the status information to the user's friends (e.g., determined based on the social network connections) to notify them that the user is currently watching the particular broadcast program on her television and that the user has given the broadcast program a thumbs-up (e.g., indicating that the user likes the show).

In another scenario, the user may wish to order a cake from a particular bakery (or a bakery in a particular area). As such, the user may turn on her television to watch a video program featuring a series of cakes from the particular bakery. When the user sees a cake that she wishes to order from the bakery, she may give a thumbs-up to initiate the ordering of the cake. For example, the tracking platform 103 may detect the user's thumbs-up gesture based on the images captured by the television's video camera. The user's thumbs-up is then associated with the frame of the video program that depicts the cake that the user wishes to order. The desired cake frame is then transmitted with the user's order to the bakery, which may then make the cake and deliver the cake to a pre-set delivery address (e.g., the user's home).

In yet another scenario, the cooking show, Fat Chef, may be playing on BBC and may be featuring a section on how to make a princess cake. A user watching the cooking show on the user's television may only want to share a particular portion of that section depicting the chef decorating the princess dress on the cake. As such, the user may perform a thumbs-up gesture to indicate that the user wishes to share the particular decorating portion. Moreover, when the thumbs-up gesture is performed, the television may contact the user's mobile phone and transmit a cake picture from the particular decorating portion to the mobile phone. The mobile phone may then perform an object recognition analysis using an application on the mobile phone to determine that the cake picture is a food item and that the mobile phone has a list of bakeries that the user recently visited (e.g., the application may be integrated with a map application on the mobile phone). The mobile phone may further invoke the application on the mobile phone with the cake picture from the television to ask the user if he/she wants to send the picture as a placement order for cake in one of the previous bakeries that the user has visited. It is noted that the mobile phone may also have location details in addition to the places which the user has visited.

By way of example, the UE 101, the tracking platform 103, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

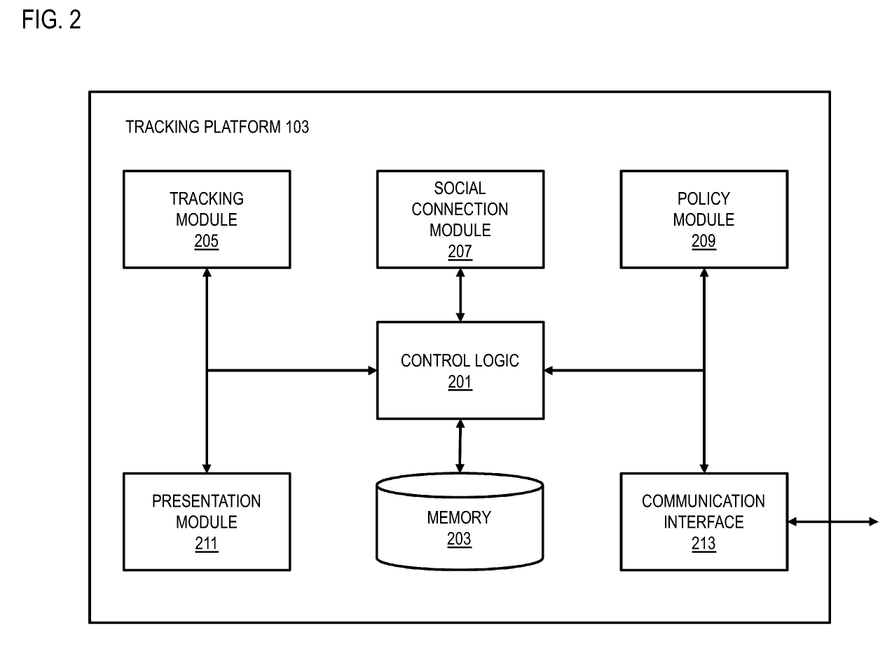

FIG. 2 is a diagram of the components of a tracking platform, according to one embodiment. By way of example, the tracking platform 103 includes one or more components for providing social interactions with programming content. It is contemplated that the functions of these components may be combined in one or more components or performed by other components of equivalent functionality. In this embodiment, the tracking platform 103 includes a control logic 201, memory 203, a tracking module 205, a social connection module 207, a policy module 209, a presentation module 211, and a communication interface 213.

The control logic 201 executes at least one algorithm for executing functions of the tracking platform 103. For example, the control logic 201 may interact with the tracking module 205 to process images of one or more users watching programming content to identify those users. For example, one or more devices (e.g., television, monitor, mobile device, etc., equipped with a capturing device) may capture images of those users as they are watching the programming content on at least one of those devices. The tracking module 205 may then be used to determine face tracking information and/or gaze tracking information via a processing of the captured images. The face tracking information and/or gaze tracking information may thereafter be utilized to determine status information associated with those users, other users, and/or the programming content. Moreover, face tracking and detection may be used on the captured images to identify the users watching the programming content.

Once identified, the control logic 201 may then direct the social connection module 207 to determine social connections among those users and/or other users, for instance, by accessing social network data of those users in the profile database 109, accessing phone contacts on those user's mobile devices, etc. The control logic 201 may further work with the policy module 209 (along with the communication interface 213) to transmit status information associated with those users, the other users, and/or the programming content. As discussed, in some cases, the transmission of status information for certain categories of programming content may be limited by a default private policy setting (e.g., private programming content). In other cases, transmission of status information with respect to particular users may also be limited by default (e.g., children under a predetermined age). Nonetheless, as indicated, these default privacy policies may be modified, and new privacy policies may be added, by users to enable customized privacy policies based on the individual preferences of those users (e.g., enable sharing of their status information to other users that are friends, disable sharing of their status information for non-friends, etc.).

The control logic 201 may further utilize the presentation module 211 to determine one or more devices (e.g., a television, a monitor, a mobile device, etc.) for presenting the programming content and/or the status information. In one use case, the presentation module 211 may work with the tracking module 205 to analyze the face tracking information and/or the gaze tracking information to determine which of the one or more devices that the users are, or will be, focusing their attention on. The presentation module 211 may thus select the device for presentation of the programming content and/or status information (e.g., a rendering of a user interface depicting the programming content and the status information) based on such a determination.

The control logic 201 may additionally utilize the communication interface 213 to communicate with other components of the tracking platform 103, the UEs 101 (e.g., the device, the other devices, etc.), the service platform 113, the services 115, the content providers 117, and other components of the system 100. For example, the communication interface 213 may initiate transmission of the status information to the respective UEs 101 and/or other components of the system 100. The communication interface 213 may further include multiple means of communication. In one use case, the communication interface 213 may be able to communicate over short message service (SMS), multimedia messaging service (MMS), internet protocol, email, instant messaging, voice sessions (e.g., via a phone network), or other types of communication.

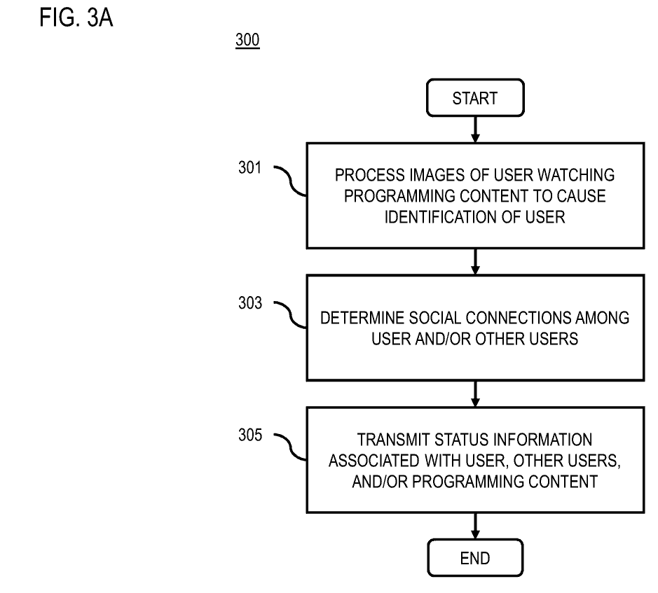

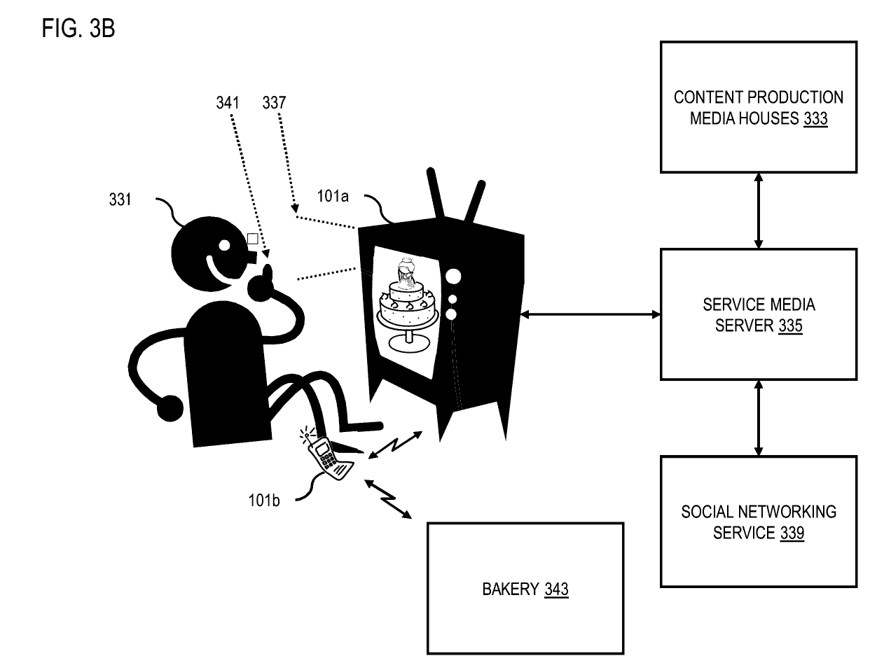

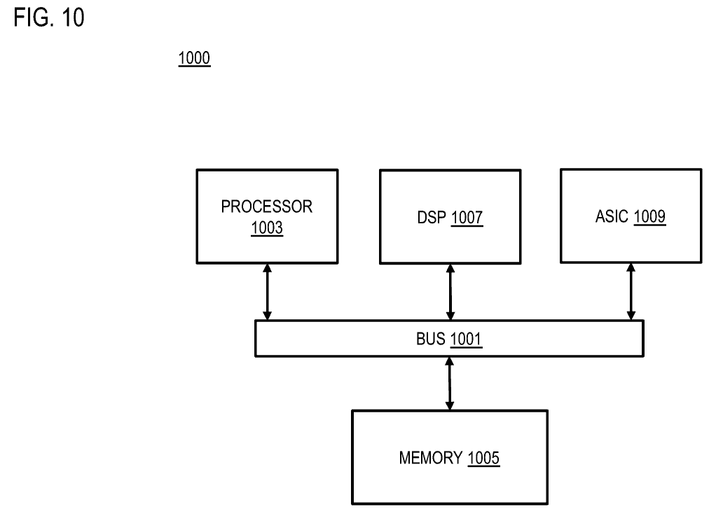

FIG. 3A is a flowchart of a process for providing social interactions with programming content, according to one embodiment. In one embodiment, the tracking platform 103 performs the process 300 and is implemented in, for instance, a chip set including a processor and a memory as shown in FIG. 10. As such, the control logic 201 can provide means for accomplishing various parts of the process 300 as well as means for accomplishing other processes in conjunction with other components of the tracking platform 103.

In step 301, the control logic 201 may process and/or facilitate a processing of one or more images of one or more users watching programming content to cause, at least in part, an identification of the one or more users. As mentioned, one or more devices (e.g., television, monitor, mobile device, etc., equipped with a capturing device) may capture images of the one or more users as they are watching the programming content on at least one of those devices. The one or more users may then be identified from the captured images, for instance, by using one or more face tracking and/or detection techniques. The control logic 201 may also, at step 303, determine one or more social connections among the one or more users, one or more other users, or a combination thereof. By way of example, once the one or more users are identified, their social network data (e.g., stored at the profile database 109) along with their phone contacts on their mobile devices may be used to discover the social connections that the one or more users have with each other as well as the social connections that the one or more users have with one or more other users.

In step 305, the control logic 201 may cause, at least in part, a transmission of status information associated with the one or more users, the one or more other users, the programming content, or a combination thereof. As discussed, in some embodiments, the status information may be based on face tracking information and/or gaze tracking information. In other embodiments, the status information may further be based on other factors, such as gestures, mood, etc. In addition, the transmission of the status information (e.g., to one or more services 115, to one or more UEs 101, etc.) may be based on one or more privacy policies associated with the one or more users, the one or more other users, the programming content, etc.

FIG. 3B is a use case diagram for providing social interactions with programming content, according to one embodiment. As shown, user 331 may be watching a cooking program (e.g., Fat Chef) on the television (e.g., UE 101a). The cooking program may, for instance, be provided to the television by one or more content production media houses 333 through service media server 335. In this scenario, one particular section of the cooking show demonstrates to its viewers how they can make a princess cake. As the user 331 is watching the television, the television may capture one or more images of the user (e.g., via the capturing process 337). The captured images may then be used to identify the user 331, for instance, through facial recognition techniques. Service media server 335 may thereafter utilize the identity of the user 331, contact listing information from the mobile phone (e.g., UE 101b) of the user 331, and the social networking service 339 to determine one or more social connections between the user 331 and other users (e.g., the social connections that the user 331 may have with other users in the social network groups associated with the user 331).

Once those social connections are identified, the service media server 335 may share status information associated with the user 301 to one or more of the other users who have particular social connections with the user 301 (e.g., only to friends of the user 301). The status information may, for instance, include the programming content that the user 301 is currently watching (e.g., the cooking program) along with the device on which the user 301 is watching the programming content on (e.g., the television). Likewise, the service media server 335 may share the status information associated with the other users to the user 301 based on their social connections. As indicated, the sharing may further be based on the privacy policies and the preferences of the respective users. These policies and preferences may, for instance, be obtained by the service media server 335 through the profile database 109 and the policy database 111.

As illustrated, the user 301 has also given a portion of the cake section of the cooking program a thumbs-up, for instance, by performing a thumbs-up gesture 341. The thumbs-up gesture 341 may indicate to the television (or the service media server 335) that the user 301 wishes to share the particular portion which depicts the chef of the cooking program decorating the princess dress on the cake. As such, the status information that is transmitted to the other users may include information indicating that the user 301 likes the particular portion. Moreover, when the thumbs-up gesture is performed, the television may contact the user's mobile phone and transmit a cake picture from the particular decorating portion to the mobile phone. The mobile phone may then perform an object recognition analysis using an application on the mobile phone to determine that the cake picture is a food item and that the mobile phone has a list of bakeries that the user 301 recently visited (e.g., the application may be integrated with a map application on the mobile phone). The mobile phone may further invoke the application on the mobile phone with the cake picture from the television to ask the user 301 if he/she wants to send the picture as a placement order for cake in one of the previous bakeries that the user 301 has visited. The mobile phone may also have location details in addition to the places which the user 301 has visited to enable the user 301 to select the bakery (e.g., bakery 343) that the order should be sent to.

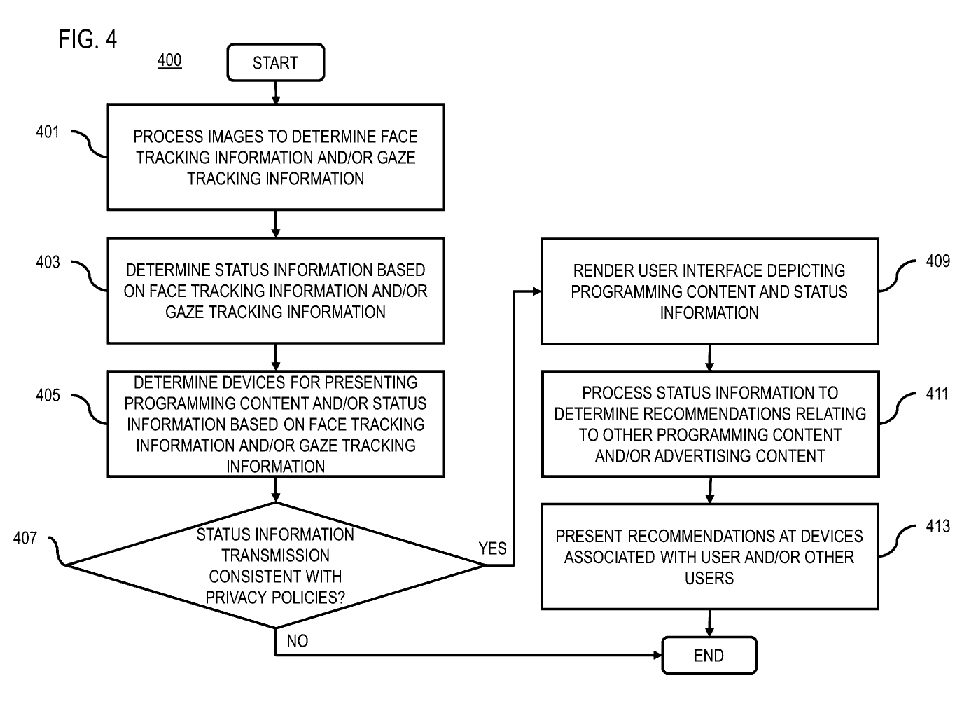

FIG. 4 is a flowchart of a process for providing presentations based on status information, according to one embodiment. In one embodiment, the tracking platform 103 performs the process 400 and is implemented in, for instance, a chip set including a processor and a memory as shown in FIG. 10. As such, the control logic 201 can provide means for accomplishing various parts of the process 400 as well as means for accomplishing other processes in conjunction with other components of the tracking platform 103.

In step 401, the control logic 201 may process and/or facilitate a processing of the one or more images to determine face tracking information, gaze tracking information, or a combination thereof. As discussed, as in step 403, the control logic 201 may determine the status information based, at least in part, on the face tracking information, the gaze tracking information, or a combination thereof. By way of example, one or more devices (e.g., television, monitor, mobile device, etc., equipped with a capturing device) may capture images of the one or more users and/or one or more other users as they are watching the programming content on at least one of those devices. The location of each user's face in the captured images, the tilt and angle of each user's head in the captured images, etc., may, for instance, be used to determine the face tracking information. Additionally, or alternatively, such information (e.g., location, tilt, angle, etc., of a user's face/head) may be used in conjunction with detected eye positions and eye movement to determine the gaze tracking information. As such, the face tracking information and/or the gaze tracking information may, for instance, be used to determine which device, programming content, etc., that each of the users are, or will be, looking at (e.g., what those users are actually watching).

In step 405, the control logic 201 may determine the one or more devices for presenting the programming content, the status information, or a combination thereof based, at least in part, on the face tracking information, the gaze tracking information, or a combination thereof. As mentioned, in the above example, the face tracking information and/or gaze tracking information may be utilized to determine which device, programming content, etc., the one or more users and/or the one or more other users are actually watching. Thus, the selection of the one or more devices for presentation of the programming content and/or the status information may be determined accordingly. In one use case, the status information that is targeted for a particular user may be presented on the device that the particular user is currently, or will immediately be, focusing her attention on. In this way, the status information may only need to be presented on the device for a short period of time to avoid substantial interference with any other content rendered on the device and still enable the status information to reach the targeted user.

In step 407, the control logic 201 may determine one or more privacy policies associated with the one or more users, the one or more other users, the programming content, or a combination thereof, and whether transmission of the status information would be consistent with those one or more privacy policies. If it is determined that transmission of the status information to certain devices (e.g., devices associated with the one or more users and/or the one or more other users) is consistent with the one or more privacy policies, the control logic 201 may, at step 409, cause, at least in part, a rendering of a user interface depicting, at least in part, the programming content and the status information (e.g., what the one or more other users are currently watching), for instance, on the device that one or more users are actually looking at.

In addition, in step 411, the control logic 201 may process and/or facilitate a processing of the status information to determine one or more recommendations relating to other programming content, advertising content, or combination thereof. The control logic 201 may then, at step 413, cause, at least in part, a presentation of the one or more recommendations at one or more devices associated with the one or more users, the one or more other users, or a combination thereof. For example, the status information relating to the one or more users and/or the one or more other users (e.g., what they are currently watching, what they have indicated that they liked while watching, etc.) may be transmitted to one or more recommendation services (e.g., services 115) to facilitate a processing of the status information for determining recommendations for the one or more users. These recommendations may be programs related to programs watched by the one or more other users (e.g., friends of the one or more users), advertising content that the one or more other users liked while watching their respective programs, etc. The recommendations may then be presented on the particular devices that the one or more users are actually watching.

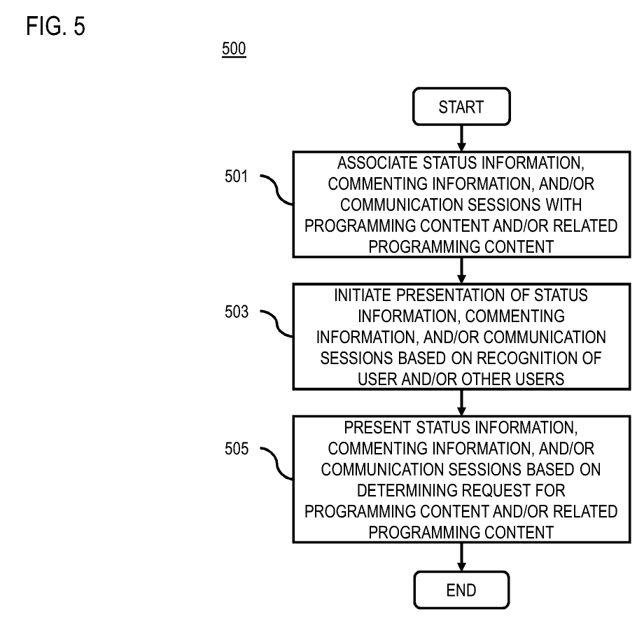

FIG. 5 is a flowchart of a process for providing presentations of status information, commenting information, and/or communication sessions, according to one embodiment. In one embodiment, the tracking platform 103 performs the process 500 and is implemented in, for instance, a chip set including a processor and a memory as shown in FIG. 10. As such, the control logic 201 can provide means for accomplishing various parts of the process 500 as well as means for accomplishing other processes in conjunction with other components of the tracking platform 103.

In step 501, the control logic 201 may determine to associate the status information, commenting information, one or more communication sessions, or a combination thereof with the programming content, related programming content, or a combination thereof. In one scenario, tracking platform 103 may work with a social networking service (e.g., via the social connection module 207). The social networking service may, for instance, provide its subscribers with their watching history and/or their friends' watching histories using data from received status information (e.g., from the tracking platform 103). In addition, the social network service may enable its subscribers to comment on each other's watching history and the respective items (e.g., programming content, advertising content, etc.) of the watching history. Furthermore, the subscribers may communicate with each other about the respective items through chats, voice sessions, etc. In conjunction with the social networking service, the tracking platform may associated the programming content and/or related programming content with related items of the watching histories, the comments, and/or the communication sessions.

The control logic 201 may, as in step 503, cause, at least in part, an initiation of the presentation of the status information, the commenting information, the one or more communication sessions, or a combination thereof based, at least in part, on a recognition of the one or more users, at least one of the one or more other users, or a combination thereof. For example, if a particular subscriber of the social networking service is detected to be looking at his television, the television (e.g., connected with the tracking platform 103) may render the subscriber's watching history along with what the subscriber's friends think about the respective items of the subscriber's history (e.g., based on the commenting information, the communication sessions, etc.). Additionally, or alternatively, the television may present the subscriber with other items (e.g., channels, programming content, advertising content, etc.), for instance, that the subscriber's friends have recommended and are currently being offered (e.g., via the electronic programming guide, via on-demand services, etc.).

The control logic 201 may also, as in step 505, cause, at least in part, a presentation of the status information, the commenting information, the one or more communication sessions, or a combination thereof based, at least in part, on determining at least one request for the programming content, the related programming content, or a combination thereof. In one use case, when a subscriber initiates a request for a particular program to be presented on his television, the television may present the subscriber with data from status information, the commenting information, the communication sessions, etc., that are associated with the requested program.

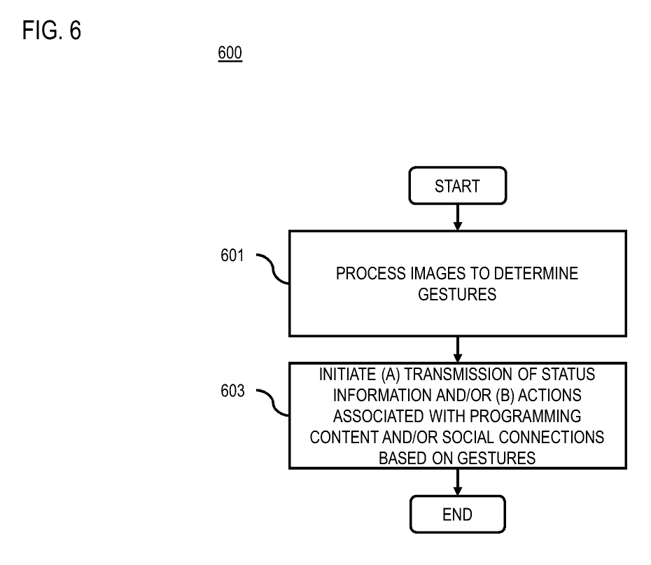

FIG. 6 is a flowchart of a process for using gestures to initiate actions, according to one embodiment. In one embodiment, the tracking platform 103 performs the process 600 and is implemented in, for instance, a chip set including a processor and a memory as shown in FIG. 10. As such, the control logic 201 can provide means for accomplishing various parts of the process 600 as well as means for accomplishing other processes in conjunction with other components of the tracking platform 103.

In step 601, the control logic 201 may process and/or facilitate a processing of the one or more images to determine one or more gestures. The control logic 201 may then, at step 603, cause, at least in part, an initiation of (a) the transmission of the status information; (b) one or more actions associated with the programming content, the one or more social connections, or a combination thereof; or (c) a combination thereof based, at least in part, on the one or more gestures. As indicated, the one or more gestures may, for instance, include a hand gesture, a facial gesture, a body gesture, etc. By way of example, a user may perform a gesture by giving two thumbs-up (e.g., pointing both of their thumbs toward the ceiling with the rest of their fingers clenched), by drooping their eyes or licking their lips (e.g., tired, thirsty, etc.), by laying their head back on a sofa (e.g., tired, relaxing, etc.), or through other actions.

In one scenario, a husband and a wife may, for instance, be watching a romantic movie on a particular channel on the family television. Although the wife's watching history may typically be updated when she is watching programming content on the family television, the wife may not particularly like romantic movies and may not want the particular romantic movie to show up on her watching history (e.g., from which recommendations for her may be based). On the other hand, the husband may love watching romantic movies, and the two users may be watching the particular romantic movie at the request of the husband. As such, the wife may give a thumbs-down gesture, and the husband may give a thumbs-up gesture. Based on these gestures, a “currently watching” status for the romantic movie may, for instance, only be added to the husband's watching history and status information. Moreover, the status information of “currently watching” the romantic may only be distributed to the husband's friends as a result of the gestures. Additionally, or alternatively, the husband's watching history and the wife's watching history may be automatically updated based on who is seen most in front of the family television (e.g., using facial recognition, gesture recognition, duration of watching, etc.). Moreover, preferences related to the watching histories (or any other preferences) may also be configured offline.

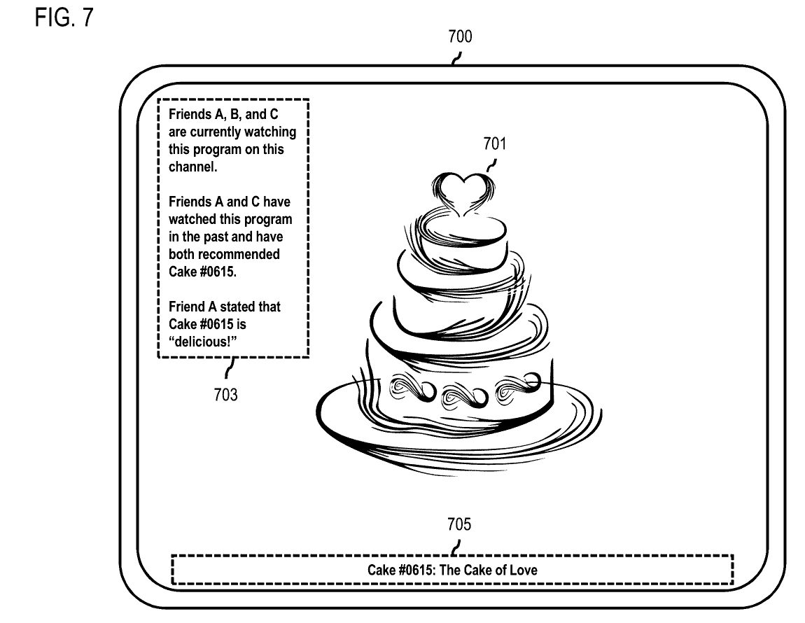

FIG. 7 is a diagram of a user interface illustrating social interactions with programming content, according to one embodiment. As shown, the user interface 700 depicts a rendering of programming content 701, notification 703, and a subtitle 705. The programming content 701 may, for instance, be a program featuring a series of cakes from a particular bakery, and the user may be watching the program to initiate an ordering of at least one of the cakes featured in the program. The notification 703 includes the current statuses of the user's friends (e.g., “Friends A, B, and C are currently watching this program on this channel”), statuses with respect to the watching history of the user's friends (e.g., “Friends A and C have watched this program in the past”), the recommendations of the user's friends (e.g., “Friends A and C . . . have both recommended Cake #0615”), and commenting information (e.g., “Friend A stated that Cake #0615 is ‘delicious! ’”). The notification 703 may, for instance, have been presented to the user when the tracking platform 103 recognized the identity of the user and that the user is currently (or will soon be) looking over at the device (e.g., television) hosting the user interface 700 based on the face tracking information and/or the gaze tracking information.

In this scenario, the user may initiate an order of a cake by giving a thumbs-up gesture when the video frame of the cake is rendered on the user interface 700. If, for instance, the user is convinced by the recommendations and the comments of his friends, the user may point a thumb up in the air with the rest of his fingers clenched during the rendering of the video frame featuring Cake #0615 (e.g., to allow the device to capture an image of his thumbs-up gesture). Once the thumbs-up gesture is detected for the particular video frame, the video frame and pre-set information (e.g., the user's name, address, and other ordering information) may be included in an order that will be transmitted to the bakery for immediate delivery.

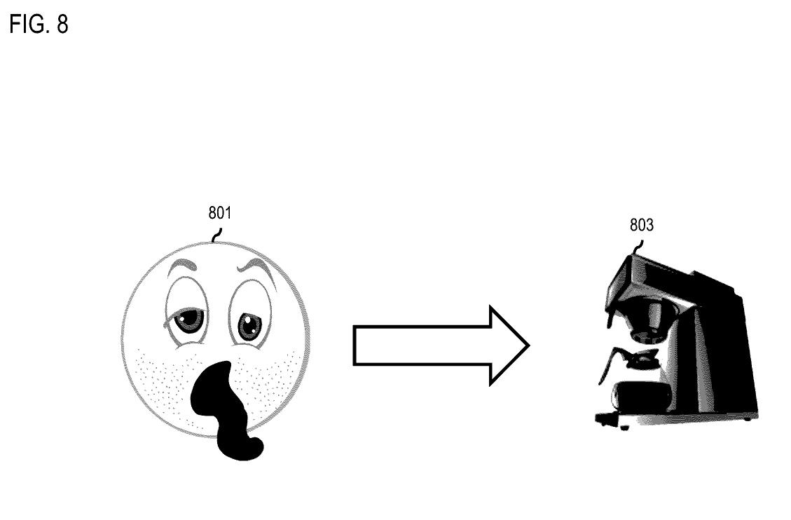

FIG. 8 is a diagram illustrating the use of gestures to initiate actions, according to one embodiment. As shown, a captured image 801 of a user watching programming content on a device may be used to determine that the user is tired based the detected facial gestures of the user (e.g., drooping eyes). As such, the determination that the user is tired may be incorporated into status information relating to the user. Thereafter, the status information may be transmitted to coffee/tea maker 803 as instructions for the coffee/tea maker 803 to make coffee or tea based on the preferences of the user. When the coffee/tea is ready, the coffee/tea maker 803 may notify the user that the coffee/tea is ready (e.g., audible alert from the coffee/tea maker 803, a text notification on the user's mobile phone, etc.).

The processes described herein for providing social interactions with programming content may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

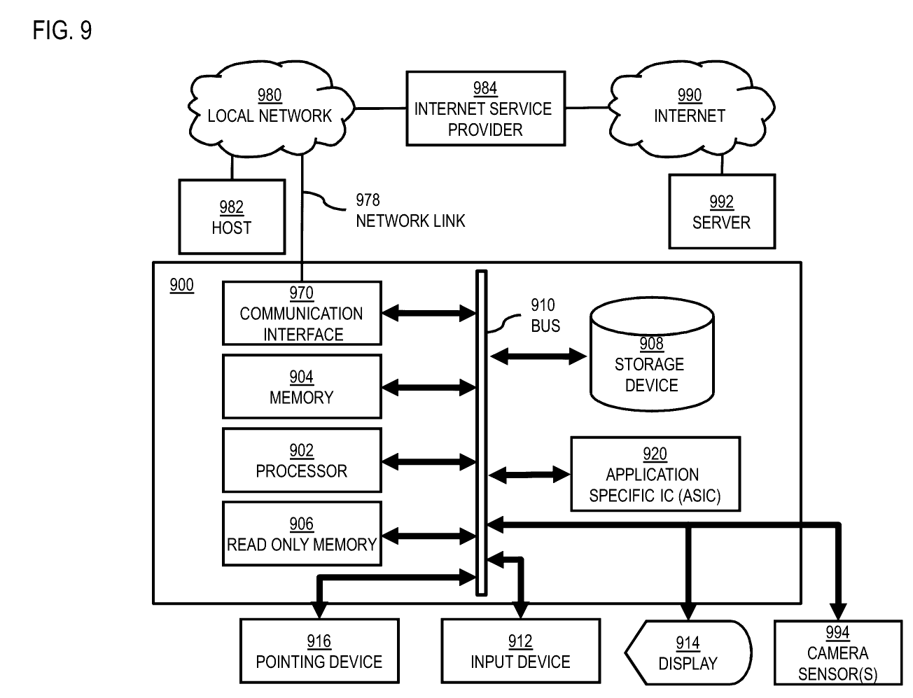

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide social interactions with programming content as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing social interactions with programming content.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing social interactions with programming content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing social interactions with programming content. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing social interactions with programming content, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing social interactions with programming content to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide social interactions with programming content as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing social interactions with programming content.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide social interactions with programming content. The memory 1005 also stores the data associated with or generated by the execution of the inventive steps.

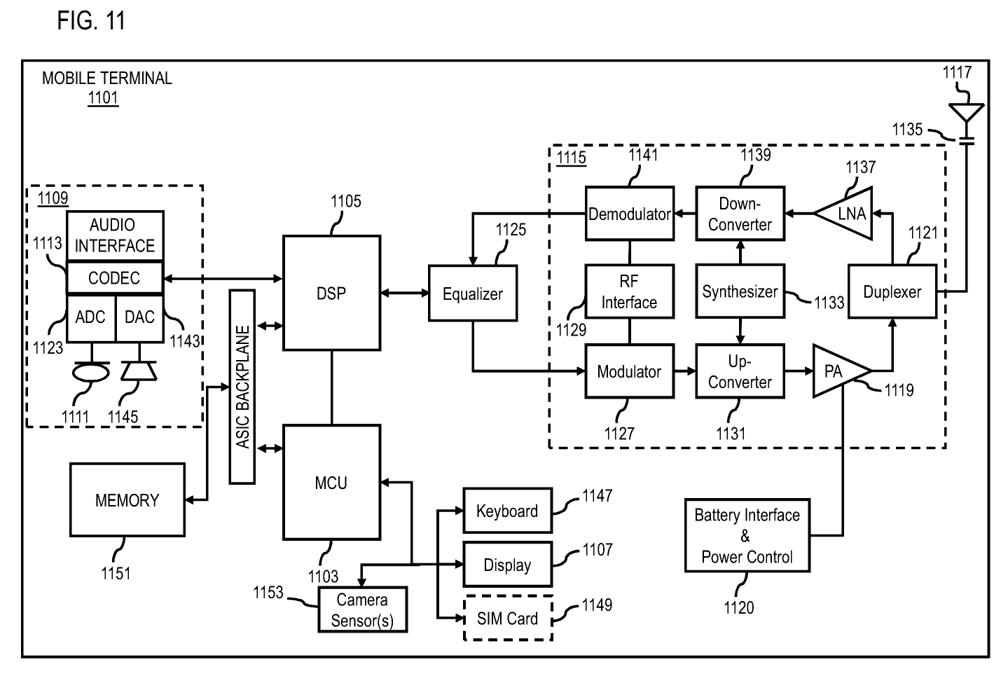

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing social interactions with programming content. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing social interactions with programming content. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide social interactions with programming content. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
processing one or more images of one or more users watching programming content to identify one or more users;
determining one or more social connections among the one or more users, one or more other users, or a combination thereof;
transmitting status information associated with the one or more users, the one or more other users, the programming content, or a combination thereof.

2. A method of claim 1, further comprising:
processing and/or facilitating a processing of the one or more images to determine face tracking information, gaze tracking information, or a combination thereof; and
determining the status information based, at least in part, on the face tracking information, the gaze tracking information, or a combination thereof.

3. A method of claim 2, further comprising:
determining one or more devices for presenting the programming content, the status information, or a combination thereof based, at least in part, on the face tracking information, the gaze tracking information, or a combination thereof.

4. A method of claim 3, wherein the one or more devices include, at least in part, a television, a monitor, a mobile device, or a combination thereof associated with the one or more users, the one or more other users, or a combination thereof.

5. A method of claim 1, further comprising:
determining one or more privacy policies associated with the one or more users, the one or more other users, the programming content, or a combination thereof,
wherein the transmission of the status information is based, at least in part, on the one or more privacy policies.

6. A method of claim 1, further comprising:
rendering a user interface depicting, the programming content and the status information.

7. A method of claim 1, further comprising:
processing and/or facilitating a processing of the status information to determine one or more recommendations relating to other programming content, advertising content, or combination thereof; and
presenting one or more recommendations at one or more devices associated with the one or more users, the one or more other users, or a combination thereof.

8. A method of claim 1, further comprising:
determining to associate the status information, commenting information, one or more communication sessions, or a combination thereof with the programming content, related programming content, or a combination thereof; and
presenting status information, the commenting information, the one or more communication sessions, or a combination thereof based on determining at least one request for the programming content, the related programming content, or a combination thereof.

9. A method of claim 8, further comprising:
initiating presentation of the status information, the commenting information, the one or more communication sessions, or a combination thereof based, at least in part, on a recognition of the one or more users, at least one of the one or more other users, or a combination thereof.

10. An apparatus comprising:
at least one processor; and
at least one memory including computer program code for one or more programs,
the at least one memory and the computer program code configured to, with the at least one processor, cause the apparatus to perform at least the following,
process one or more images of one or more users watching programming content to cause, at least in part, an identification of the one or more users;
determine one or more social connections among the one or more users, one or more other users, or a combination thereof;
transmit status information associated with the one or more users, the one or more other users, the programming content, or a combination thereof.

11. An apparatus of claim 10, wherein the apparatus is further caused to:
process one or more images to determine face tracking information, gaze tracking information, or a combination thereof; and
determine the status information based, on the face tracking information, the gaze tracking information, or a combination thereof.

12. An apparatus of claim 11, wherein the apparatus is further caused to:
determine one or more devices for presenting the programming content, the status information, or a combination thereof based, at least in part, on the face tracking information, the gaze tracking information, or a combination thereof.

13. An apparatus of claim 12, wherein the one or more devices include, at least in part, a television, a monitor, a mobile device, or a combination thereof associated with the one or more users, the one or more other users, or a combination thereof.

14. An apparatus of claim 10, wherein the apparatus is further caused to:
determine one or more privacy policies associated with the one or more users, the one or more other users, the programming content, or a combination thereof,
wherein the transmission of the status information is based, at least in part, on the one or more privacy policies.

15. An apparatus of claim 10, wherein the apparatus is further caused to:
render a user interface depicting, the programming content and the status information.

16. An apparatus of claim 10 , wherein the apparatus is further caused to:
process the status information to determine one or more recommendations relating to other programming content, advertising content, or combination thereof; and
present the one or more recommendations at one or more devices associated with the one or more users, the one or more other users, or a combination thereof.

17. An apparatus of claim 10, wherein the apparatus is further caused to:
determine to associate the status information, commenting information, one or more communication sessions, or a combination thereof with the programming content, related programming content, or a combination thereof; and
preent the status information, the commenting information, the one or more communication sessions, or a combination thereof based on determining at least one request for the programming content, the related programming content, or a combination thereof.

18. An apparatus of claim 17, wherein the apparatus is further caused to:
initiating of the presentation of the status information, the commenting information, the one or more communication sessions, or a combination thereof based, at least in part, on a recognition of the one or more users, at least one of the one or more other users, or a combination thereof.

19. A computer program product including one or more sequences of one or more instructions which, when executed by one or more processors, cause an apparatus to at least perform the steps:
processing one or more images of one or more users watching programming content to cause an identification of the one or more users;
determining one or more social connections among the one or more users, one or more other users, or a combination thereof;
transmitting status information associated with the one or more users, the one or more other users, the programming content, or a combination thereof.

20. A computer program product of claim 19, further comprising:
processing the one or more images to determine face tracking information, gaze tracking information, or a combination thereof; and
determining the status information based, on the face tracking information, the gaze tracking information, or a combination thereof.
